(19) United States
(12) Patent Application Publication
(10) Pub. No.: US 2012/0036337 A1
(43) Pub. Date: Feb. 9, 2012

(54) Processor on an Electronic Microchip Comprising a Hardware Real-Time Monitor

(75) Inventor: Philippe GROSSI, Saint Marcel (FR)

(73) Assignee: THALES, Neuilly-sur-Seine (FR)

(21) Appl. No.: 13/155,260

(22) Filed: Jun. 7, 2011

(30) Foreign Application Priority Data
Aug. 6, 2010 (FR) FR 1002416

(51) Int. Cl. G06F 9/302; G06F 9/38

(52) U.S. Cl. 712/208; 712/E09.017; 712/E09.045; 712/E09.028

(57) ABSTRACT

A processor on an electronic microchip is capable of executing mathematical processes, each of said processes being associated with a priority, and includes means for the management of the processes, the means for the management of the processes taking the form of hardware, the management of the processes comprising the activation and the suspension of the processes and the management of the execution of the processes according to their priorities.

### CROSS-REFERENCE TO RELATED APPLICATION

This application claims priority to foreign French patent application No. FR 1002416, filed on Jun. 8, 2010, the disclosure of which is incorporated by reference in its entirety.

### FIELD OF THE INVENTION

The invention relates to real-time systems and, more particularly, synthesizable processors.

### BACKGROUND

Synthesizable processors can be synthesized with logic gates using high level descriptions, for example using VHDL (VHSIC Hardware Description Language).

These processors may be single or multi-core, in other words they can comprise one or more processors. These processors can be synthesized on ASIC (Application-Specific Integrated Circuit) targets which are specialized integrated circuits or on PLD (Programmable Logic Devices) targets which are programmable logic circuits such as CPLD (Complex Programmable Logic Devices) or FPGA (Field-Programmable Gate Arrays).

For real time to be taken into account by a system capable of executing processes depends, on the one hand, on the capacities of the hardware (processors, interrupt managers, etc.) and, on the other hand, on the capacities of the OS (Operating System) and, more particularly, of the real-time monitor. The role of the real-time monitor is the management of the processes. The management of the processes comprises: the order arrangement of the processes, the management of the process priorities, the creation and the activation of the processes, the interruption/suspension of the processes. It is recalled that there exist various categories of operating system: hard real-time operating systems, soft real-time operating systems and standard operating systems.

The notion of real time is linked to the determinism and to the time required for an operating system to change context. Change of context means a transfer from the handling of one process by the processor to the handling of another process. When this time is deterministic, then it is referred to as real time. When this latency time is reduced, then it is referred to as hard real time. When this time is not a criterion, the operating system is not classed as real-time.

The real-time operating systems according to the prior art can meet a performance for change of context, upon interrupt, of the order of microseconds (2-15 μs) with a tolerance of around half a microsecond (determinism ˜0.5 μs).

The problem of determinism and of latency is currently generally addressed by way of several solutions:
the recourse to external solutions wired on a board or FPGA which present the drawback of adding limitations to the architectures (external wired functions) locking in the system (upgrade, maintainability, etc.),
the reduction in the loading factor of the processors in order to increase their availability which has the drawback of leading to an oversizing of the systems, and
the increase in system frequencies and internal frequencies of the processors which results in an increase in the electrical power consumption of the systems.

Systems considered as critical systems, avionics applications for example, comprise not only real-time constraints but, in addition, constraints on operational security. These operational security constraints guarantee an improved reliability of the systems.

The problem of operational security is generally addressed by way of specific operating systems and of complex digital architectures associating special processors and programmable logic processors, leading to several drawbacks: an increased financial cost (oversizing of the systems, development of specific operating system) and a reduction in processor performance due to the disabling of certain sub-systems, for example memory caches and speculative branching.

### SUMMARY OF THE INVENTION

The invention notably overcomes the aforementioned problems by providing a processor on an electronic microchip capable of executing processes allowing the determinism and the latency time to be improved for onboard applications on an electronic microchip.

For this purpose, a subject of the invention is a processor on an electronic microchip capable of executing mathematical processes, each of the said processes being associated with a priority, characterized in that it comprises means for the management of the processes, the means for the management of the processes taking the form of hardware, the management of the processes comprising the activation and the suspension of the processes and the management of the execution of the processes according to their priorities.

One advantage of the invention is to significantly reduce the latency of the processors. Indeed, with the invention, a change of context can be carried out in one or two cycles of the processor. For a processor running at 100 MHz, the time for change of context is then around ten nanoseconds. The reduction in the time for change of context is vital when the ratio time for change of context over processing time is high. This is the case in systems comprising many processes where the processes require relatively little processing time.

The invention also allows the determinism of the processors to be enhanced by eliminating the change of context code and hence the time associated with it.

Another advantage of the invention is a reduction in memory usage and in the processing load on the real-time operating system. The management of the processes is not carried out via software, as in the prior art, but is handled directly via hardware means. It does not therefore use any memory or processor processing time.

According to one feature of the invention, each process comprises a program described in the form of instructions, the processor furthermore comprising a program memory for storing the instructions of the programs, a data memory for storing data handled by the programs, an arithmetic and logic unit for executing arithmetic and logic operations, and a controller for decoding the instructions of the programs and activating the arithmetic and logic unit according to the decoded instructions, the means for managing the processes being incorporated into the controller.

According to a preferred embodiment, the program memory comprising a plurality of pages, the data memory comprising a plurality of pages, and the arithmetic and logic unit comprising a plurality of register banks for storing intermediate calculations, each process is associated with a page of the program memory, a page of the data memory and a register bank which are dedicated to it.

These features allow, on the one hand, the costs of contextual changes to be reduced and, on the other hand, the operational security of the processors to be enhanced. This is particularly important in critical fields such as avionics or rail traffic applications. The operational security is obtained by virtue of a physical segregation of the data and of the programs right within a synthetizable core.

### BRIEF DESCRIPTION OF THE DRAWINGS

The invention will be better understood and other advantages will become apparent upon reading the detailed description presented by way of non-limiting example and with the aid of the figures, amongst which:

FIG. 1 shows an architecture of a processor according to the invention.

FIG. 2 shows a simplified view of a controller.

FIG. 3 shows an architecture of a processor according to the invention with physically separate memories.

### DETAILED DESCRIPTION

The invention relates to a processor on an electronic microchip capable of executing mathematical processes. The processor comprises means for the management of the processes which take the form of hardware. The management of the processes comprises the activation and the suspension of the processes and the management of the execution of the processes according to their priorities.

Each of the processes is associated with a priority, the order of execution of the processes being determined based on these priorities. Each of the processes comprises a program described in the form of instructions.

The embedding of the means for management of the processes within a processor requires a processor with a dedicated architecture.

This embedding leads to the constraint that the processor must be specifically developed with an embedded OS (Operating System). The processors of the prior art implement a control logic that is external to the processor. The advantage of the embedded solution is a gain in speed and above all in operational security, the controller having access to all the internal mechanisms of the processor.

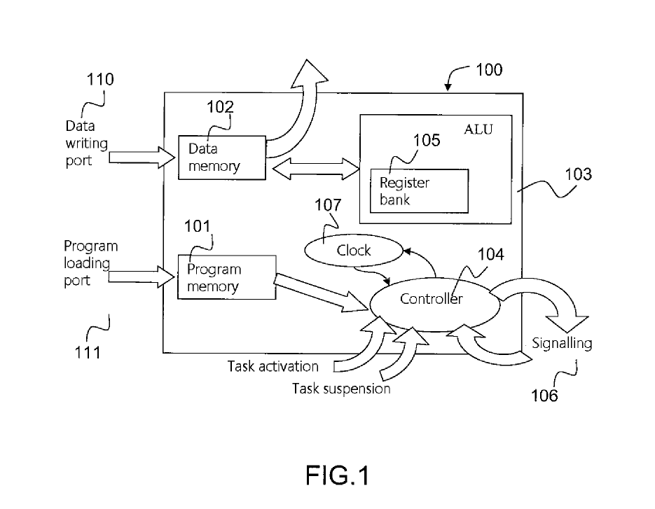

FIG. 1 shows an architecture for a processor comprising means for management of the processes provided in the form of hardware. This representation is simplified to facilitate understanding of the mechanism involved and does not therefore show the complete contents of a processor, such as FPU, memory controllers, management of the inputs/outputs, etc.

The processor 100 comprises:
a program memory 101 for storing the instructions of the programs, the programs coming from a program loading port 111,
a data memory 102 for storing data handled by the programs, for example data coming from a data writing port 110 or results coming from an arithmetic and logic unit 103,
an arithmetic and logic unit (ALU) 103 for executing arithmetic and logic operations, and
a controller 104 for decoding the instructions of the programs stored in the program memory 101 and for activating the arithmetic and logic unit 103 according to the decoded instructions.

The controller 104 receives external signals, for example:
Task activation, activating the execution of a process,
Task suspension, suspending the execution of a process,
Task termination, terminating the execution of a process.
Signalling codes 106 to authorize or limit access to a resource shared by other processors for example,
Clock for waking up (activating) the process in wait state at a given time or for interrupting an infinite wait loop (time-out).

Signalling codes 106 are also used to drive the control of the processes. The control of the processes therefore takes the form of hardware.

The controller can also receive signals called data-memory triggers for modification of shared memory allowing processes waiting for this type of event to be woken up.

The controller 104 maintains the update of a table recording the states of the processes (active, priority, privileges, etc.) for its internal management of the processes, but also for locking-out/authorizing the loading of new programs/processes into these program memories.

A real-time monitor is installed as hardware within the controller 104. The controller comprises an instruction decoding pipeline to which is added a mechanism for the management of the processes comprising: the activation and the suspension of processes, the management of the process priorities, of the signalling codes, of the timings, etc.

The controller 104 provides all of the primary functions of an operating system (order arrangement of processes, signalling codes, clock) allowing a multi-process system to be created and managed.

The process synchronizations are conventionally assigned to a signalling mechanism and message queues.

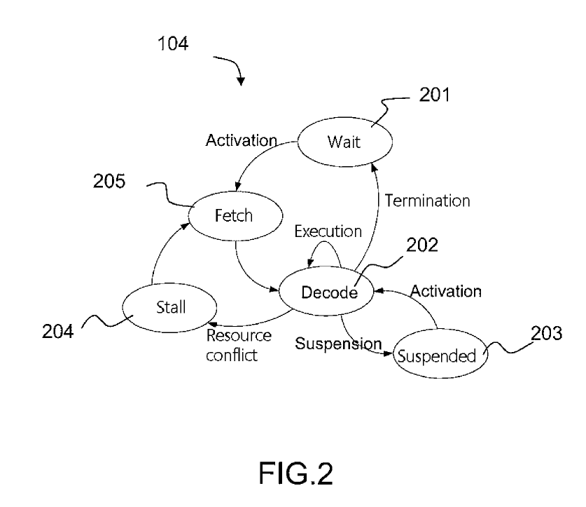

FIG. 2 shows a simplified view of the controller 104. The management of the signalling codes and the control tables for the tasks are not shown in the figure.

According to one feature of the invention, the controller 104 comprises a state machine comprising the following states:
The decoding state 202 corresponding to a state for execution of a process where instructions coming from a pipeline are decoded,
The wait state 201 corresponding to a state waiting for a process after it has been decoded, a process in a wait state can be reactivated, it then going into a fetch state 205;
The fetch state 205 corresponds to a reset of the pipeline delivering the instructions; after it has been reset, the process is ready for decoding;
The suspension state 203 corresponds to a state where the process is halted, for example following a signal indicating a process with a higher priority that is to be executed or indicating that a signalling code is not ready; a suspended process can be activated for example by a signal indicating that it has the highest priority or that the signalling code is ready;
The stall state 204, for example following a resource conflict, allows the controller to resolve the conflict and to re-synchronize the pipeline.

In one variant embodiment of the invention the processor comprises a memory that is shared in order to allow the exchange of data between processes. In this case, the controller also provides auxiliary functions completing the operational security, such as for example controlling access to the shared memory by a system of locking and unlocking of the memory.

The controller can also provide the access control to writing a program page when a process is active, by means of its process management record tables.

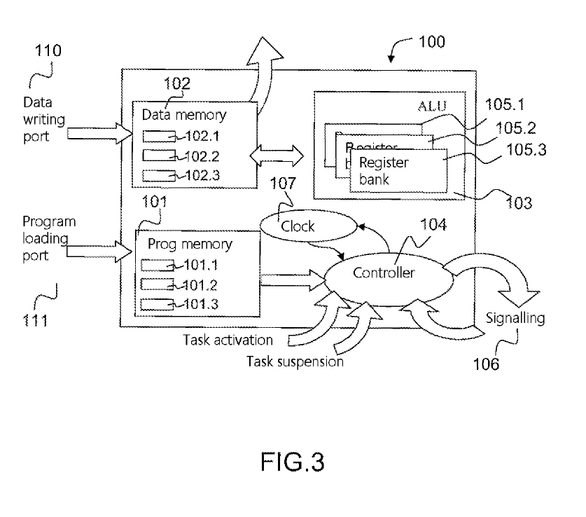

FIG. 3 shows a variant of the invention in which the program memory 101 comprises a plurality of pages 101.1, 101.2, 101.3; the data memory 102 comprises a plurality of pages 102.1, 102.2, 102.3; and the arithmetic and logic unit 103 comprises a plurality of register banks 105.1, 105.2, 105.3 for storing intermediate calculations. Each process is associated with a page of the program memory 101, a page of the data memory 102 and a register bank 105.1, 105.2, 105.3, which are dedicated to it.

Thus, each process has its program page, its data page and a dedicated register bank, thus ensuring a strict physical segregation of the data.

This physical segregation allows the contexts to be isolated and hence the operational security of the processor to be improved.

A special memory page (shared memory) allows the exchange of data between the internal processes and with the other processors.

The isolation of the pages also allows the change of context to be accelerated: it being no longer necessary to save the context.

The invention also relates to a multi-processor system on an electronic microchip comprising a plurality of processors according to the invention. The processors are connected to one another by means that are already known, such as: a master/slave or multi-master bus with arbitrage, a ring connection, multilayer switch bus multiplexers, etc. The multi-processor system furthermore comprises means for accessing an external memory of the DDR (Double Data Rate) type or Flash or SRAM (Static Random Access Memory) asynchronous memories for example, via dedicated memory controllers (DMA: Direct memory access).

1. A processor on an electronic microchip capable of executing mathematical processes, each of the said processes being associated with a priority, said processor comprising:
means for the management of the processes, the means for the management of the processes taking the form of hardware, the management of the processes comprising the activation and the suspension of the processes and the management of the execution of the processes according to their priority, each process comprising a program described in the form of instructions,
a program memory for storing the instructions of the programs,
a data memory for storing data handled by the programs,
an arithmetic and logic unit for executing arithmetic and logic operations, and a controller for decoding the instructions of the programs and activating the arithmetic and logic unit according to the decoded instructions, the means for managing the processes being incorporated into the controller,
the program memory comprising a plurality of pages, the data memory comprising a plurality of pages, and the arithmetic and logic unit comprising a plurality of register banks for storing intermediate calculations, each process being associated with one page of the program memory, one page of the data memory and one register bank, which are dedicated to it.

2. A multiprocessor system on an electronic microchip, comprising a plurality of processors according to claim 1.

3. The processor according to claim 1, in which the controller comprises a state machine comprising the following states:
a decoding state corresponding to a state for execution of a process where instructions coming from a pipeline are decoded;
a wait state corresponding to a state waiting for a process after it has been decoded, where a process in a wait state can be reactivated, then going into a fetch state;
a fetch state corresponding to a reset of a pipeline delivering the instructions;
a suspension state corresponding to a state where the process is halted;
a stall state occurring following a resource conflict and allowing the controller to resolve the conflict and to re-synchronize the pipeline.

4. A multiprocessor system on an electronic microchip, comprising a plurality of processors according to claim 3.
